(19) United States
(12) Patent Application Publication
(10) Pub. No.: US 2014/0121949 A1
(43) Pub. Date: May 1, 2014

(54) Fuel Pump Control Method for Vehicle

(71) Applicants: HYUNDAI MOTOR COMPANY, Seoul (KR); KIA MOTORS CORPORATION, Seoul (KR)

(72) Inventors: Ju Tae SONG, Suwon-si (KR); Cheol Hun Cho, Suwon-si (KR)

(73) Assignees: Kia Motors Corporation, Seoul (KR); Hyundai Motor Company, Seoul (KR)

(21) Appl. No.: 13/706,059

(22) Filed: Dec. 5, 2012

(30) Foreign Application Priority Data
Oct. 25, 2012 (KR) 10-2012-0119269

(51) Int. Cl. F02D 41/30

(52) U.S. Cl. CPC F02D 41/3005
USPC 701/104

(57) ABSTRACT

A fuel pump control method can improve acceleration response and operability of a vehicle by allowing a rapid increase in fuel pressure of a low-pressure pump in re-acceleration after fuel cut in a vehicle equipped with a fuel supply system where a low-pressure pump and a high-pressure pump, which are variably controlled, are connected in series.

### CROSS-REFERENCE TO RELATED APPLICATION

The present application claims priority of Korean Patent Application Number 10-2012-0119269 filed Oct. 25, 2012, the entire contents of which application is incorporated herein for all purposes by this reference.

### BACKGROUND OF INVENTION

1. Field of Invention

The present invention relates to a fuel pump control method for a vehicle, and more particularly, to a technology of controlling a low-pressure pump of a vehicle equipped with a fuel supply system including a low-pressure pump and a low pressure pump.

2. Description of Related Art

Recently, a fuel supply system connected with a low-pressure pump and a high-pressure pump in series and allows the high-pressure pump to pump up again and supply the fuel, which is pumped by the low-pressure pump, to an injector at a high pressure is used for engines.

The recent low-pressure pump is operated to be able to change the pressure and the flow rate of fuel that is pumped, in consideration of the traveling situations of a vehicle in order to improve fuel efficiency of the vehicle, and as shown in FIG. 1, a controller increases or maintains Pulse Width Modulation (PWM) duty of the low-pressure pump by comparing a measured pressure that is actually measured with a target pressure set in consideration of the traveling situations of the vehicle.

As described above, when a vehicle in which the PWM duty of a low-pressure pump is controlled in accordance with the traveling situation of the vehicle travels on an express way and fuel cut is operated, the injector stops injecting, so that the fuel-measured pressure of the low-pressure pump increases even though the PWM duty is decreased, and the measured pressure is higher than the target pressure; therefore, the PWM duty is set to the minimum value.

When the driver accelerates the vehicle again by operating the acceleration pedal in the situation described above, the measured pressure of the low-pressure pump is required to decrease lower than the target pressure to increase the PWM duty again, but this process takes time and the fuel pressure of the low-pressure pump increases to an appropriate level after some time has passed from when fuel cut is actually stopped by the driver operating the acceleration pedal, so that response and operability of the vehicle decrease.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with prior art.

Various aspects of the present invention provide for a fuel pump control method for a vehicle that improves acceleration response and operability of a vehicle equipped with a fuel supply system where a low-pressure pump and a high-pressure pump, which are variably controlled, are connected in series, by allowing a rapid increase in fuel pressure of the low-pressure pump in re-acceleration after fuel cut.

Various aspects of the present invention provide for a fuel pump control method for a vehicle includes: a stop determination step that determines whether a fuel cut function of an engine stops; a control amount comparison step that compares the current control amount with a predetermined reference control amount of a fuel pump right before the fuel cut function stops; and a control amount replacement step that sets the control amount of the fuel pump to a predetermined jump control amount, when the current control amount is less than the reference control amount, as the result of performing the control amount comparison step.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a fuel pump control method for a vehicle in the related art.

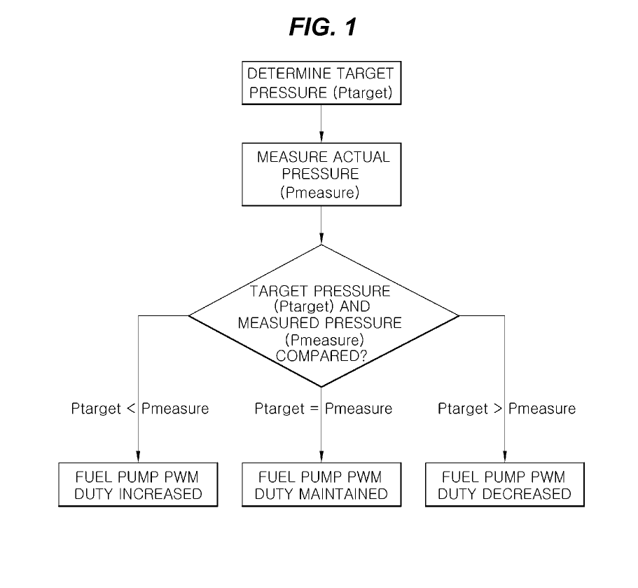

FIG. 2 is a diagram illustrating an exemplary fuel pump control method for a vehicle according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the inventions) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

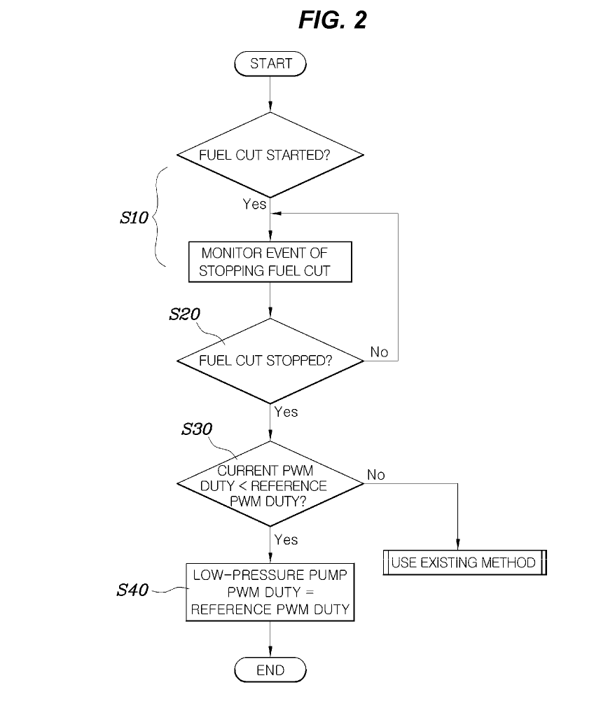

Referring to FIG. 2, various embodiments of a fuel pump control method for a vehicle of the present invention may include: a stop determination step S20 that determines whether a fuel cut function of an engine stops; a control amount comparison step S30 that compares the current control amount with a predetermined reference control amount of a fuel pump right before the fuel cut function stops; and a control amount replacement step S40 that sets the control amount of the fuel pump to a predetermined jump control amount, when the current control amount is less than the reference control amount, as the result of performing the control amount comparison step S30.

That is, when the fuel cut function is stopped by a driver pressing down an acceleration pedal and the control amount of the fuel pump that is currently controlled does not reach a reference control amount by performing the control amount comparison step S30, the control amount of the fuel pump is immediately replaced by the jump control amount at a level of ensuring response and stability in traveling of the vehicle such that acceleration ability of the vehicle can be rapidly ensured and the vehicle can stably travel.

In various embodiments, the control amount means a PWM duty value for controlling the fuel pump, but may be any physical quantity as long as it is a physical quantity for controlling the operation of the fuel pump such as the current that controls the motor in the fuel pump.

In various embodiments, the jump control amount of the control amount replacement step S40 is set to the same value as the reference control amount of the control amount comparison step S30. That is, the jump control amount and the reference control amount are the reference PWM duties in FIG. 2, which are the same value.

Obviously, the reference control amount and the jump control amount may be set to different values. For example, the reference control amount may be set to a relatively low value in order to decide a level where it is determined that the current control amount causes a problem in acceleration ability and response of the vehicle in stopping fuel cut, and the current control amount is a value smaller than the reference control amount, as described above, so that the control amount to be actually applied to the fuel pump may be set to be relatively higher than the reference control amount such that more rapid and appropriate control can be achieved, in order to improve acceleration ability and response of the vehicle.

A monitoring step S10 that monitors whether the fuel cut function stops, when the fuel cut function has started is provided before the stop determination step S20. That is, when the fuel cut function starts, monitoring is performed until the fuel cut function stops, by repeating an event to stop fuel cut such as operating the acceleration pedal by the driver.

Therefore, when the fuel cut function is stopped by the driver operating the acceleration pedal during monitoring described above, the control amount comparison step S30 and the control amount replacement step S40 are immediately performed to operate the fuel pump such that sufficient fuel pressure is achieved, so that response and acceleration ability of the vehicle are improved and a stable traveling state can be ensured, thereby consequently improving productivity of the vehicle.

Obviously, when the current control amount is not less than the reference control amount, as the result of performing the control amount comparison step S30, control is performed in accordance with the fuel pressure control method of the related art.

For reference, the fuel pump described herein means the low-pressure pump in the fuel supply system equipped with both a low-pressure pump and a high-pressure pump.

The present invention can improve acceleration response and operability of a vehicle by allowing a rapid increase in fuel pressure of a low-pressure pump in re-acceleration after fuel cut in a vehicle equipped with a fuel supply system where a low-pressure pump and a high-pressure pump, which are variably controlled, are connected in series.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel pump control method for a vehicle comprising:
a stop determination step S20 that determines whether a fuel cut function of an engine stops;
a control amount comparison step S30 that compares the current control amount with a predetermined reference control amount of a fuel pump right before the fuel cut function stops; and
a control amount replacement step S40 that sets the control amount of the fuel pump to a predetermined jump control amount, when the current control amount is less than the reference control amount, as the result of performing the control amount comparison step S30.

2. The method of claim 1, wherein the jump control amount of the control amount replacement step S40 is set to the same value as the reference control amount of the control amount comparison step S30.

3. The method of claim 1, further comprising a monitoring step S10 that monitors whether the fuel cut function stops, when the fuel cut function has started is provided before the stop determination step S20.

4. The method of claim 1, wherein the control amount of is a PWM duty value for controlling a fuel pump.

5. The method of claim 2, wherein the control amount of is a PWM duty value for controlling a fuel pump.

6. The method of claim 3, wherein the control amount of is a PWM duty value for controlling a fuel pump.

7. An electronic control controller configured to perform the fuel pump control method of claim 1.

8. An electronic control controller configured to perform the fuel pump control method of claim 2.

9. An electronic control controller configured to perform the fuel pump control method of claim 3.
